(19) United States
(12) Patent Application Publication
(10) Pub. No.: US 2019/0384255 A1
(43) Pub. Date: Dec. 19, 2019

(54) AUTONOMOUS PREDICTIVE REAL-TIME MONITORING OF FAULTS IN PROCESS AND EQUIPMENT

(71) Applicant: Honeywell International Inc., Morris Plains, NJ (US)

(72) Inventors: Meenakshi Sundaram Krishnaswamy, Edmonton (CA); Qing Zhao, Edmonton (CA); Bahador Rashidi, Edmonton (CA)

(21) Appl. No.: 16/012,542

(22) Filed: Jun. 19, 2018

(51) Int. Cl. G05B 19/4063; G05B 13/02

(52) U.S. Cl. CPC G05B 19/4063; G05B 2219/37214; G05B 13/026

(57) ABSTRACT

A framework for autonomous predictive health monitoring includes online monitoring, offline training, and self-learning components. The monitoring component includes analyzing streaming incoming process data, which includes process variable and key performance indicators (KPIs), from multiple sources, in real time, to determine an overall health index, determine faults, diagnose and isolate faulty process variables that contribute to the health index, and predict a trend and a magnitude of the health index before failure. The self-learning component includes services linked to event management, to correct the health index from probabilities calculated based on operator feedback on true or false events after analyzing each of the detected events, self-tune limits and other model parameters, and trigger training of a model when a new normal pattern is detected. The offline training component creates models to classify each of the moving data window, cluster training windows, remove duplicate windows, and minimize training data storage size.

### TECHNICAL FIELD

This disclosure relates generally to process health monitoring systems. More specifically, this disclosure relates to systems and methods for autonomously identifying and processing signals to detect faults, isolate variables that are a source of the faults, and predict faults that have not yet occurred.

### BACKGROUND

Industrial process control and automation systems are routinely used to automate large and complex industrial processes. These types of systems typically include meters to monitor the industrial processes and provide information to the business, for example to allow for auditing of the industrial processes and to monitor for failures in the industrial processes. Additionally, data from the meters may be used to perform predictive monitoring to estimate upcoming faults with sufficient lead time to correct those faults.

### SUMMARY

This disclosure provides systems and methods for autonomously identifying and processing signals to detect faults, isolate variables that are a source of the faults, and predict faults that have not yet occurred.

In a first embodiment, a method includes, in a learning and preprocessing operation, autonomously analyzing, by a processor, historical data to determine data characteristics of the historical data and preconditioning settings for the processor to provide preprocessed historical data, the historical data including process variable and key performance indicators (KPIs) associated with a process. The method further includes providing a plurality of models, each associated with different determined data characteristics, after determining the data characteristics of the historical data, selecting one of the plurality of models in a data driven selection process, and training the selected model with the preprocessed historical data to define a baseline model. The method also includes, in a real-time operation, preprocessing real-time data parameterized with the preconditioning settings, applying the baseline model to the preprocessed real-time data to determine existence of faults to determine an overall health index for select process variables, diagnosing and isolating, from the select process variables, faulty process variables determined to contribute to the health index, and predicting a trend, a magnitude of the health index, and a contribution thereto of the faulty process variables.

In a second embodiment, a method includes providing a database for storing model information for a plurality of available predictive models and for storing configuration information for configuring a predictive system, and storing, in the database, historical data for at least one process to be operated upon by the predictive system. The method also includes operating, in a learning mode, a processor to select historical data from the database for a given process, analyze a data structure in the selected historical data, determine and apply preconditioning parameters to precondition the selected historical data, select one of the stored predictive models based on the data structure, and train and test the selected predictive model to create a baseline model. The method further includes operating the processor in an online mode to receive online data as process variables, key performance indicators (KPIs), and non-process data from the at least one process, preprocess the received online data in accordance with the preconditioning parameters determined and used in the learning mode to precondition and parse the received online data as preprocessed process variables, operate the baseline model on the preprocessed process variables and KPIs to determine residuals, compare the determined residuals with stored fault threshold values to determine if a fault exists, and when the fault has been determined to exist, analyze the fault with a predetermined fault analysis routine using the baseline model.

In a third embodiment, a predictive system includes a database configured to store model information for a plurality of available predictive models and to store configuration information for configuring the predictive system, where the database is configured to store historical data for at least one process to be operated upon by the predictive system, and a processor. The processor is configured to operate in a learning mode to select historical data from the database for a given process, analyze a data structure in the selected historical data, determine and apply preconditioning parameters to precondition the selected historical data, select one of the stored predictive models based on the data structure, and train and test the selected predictive model to create a baseline model. The processor is further configured to operate in an online mode to receive online data as process variables, key performance indicators (KPIs) and non-process data from the at least one process, and to perform fault analysis using the online data. The processor operating in the online mode to perform fault analysis further configured to preprocess the received online data in accordance with the preconditioning parameters determined by the processor to precondition and parse the received online data as preprocessed process variables, operate the baseline model on the preprocessed process variables and KPIs to determine residuals, compare the determined residuals with stored fault threshold values to determine if a fault exists, and when the fault has been determined to exist, analyze the fault with a predetermined fault analysis routine using the baseline model.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a portion of an example industrial process control and automation system according to this disclosure;

FIG. 2 illustrates an example device for performing autonomous data-driven health monitoring in industrial plants according to this disclosure;

FIG. 3 illustrates a block diagram of an example autonomous data-driven predictive monitoring system according to embodiments of this disclosure;

FIG. 4 illustrates an example copying and shifting operation;

FIG. 5 illustrates a block diagram of a decomposition-based cascaded approach; and

FIGS. 6A-6G illustrate example flowcharts depicting the operational flow for the data-driven predictive monitoring operation.

### DETAILED DESCRIPTION

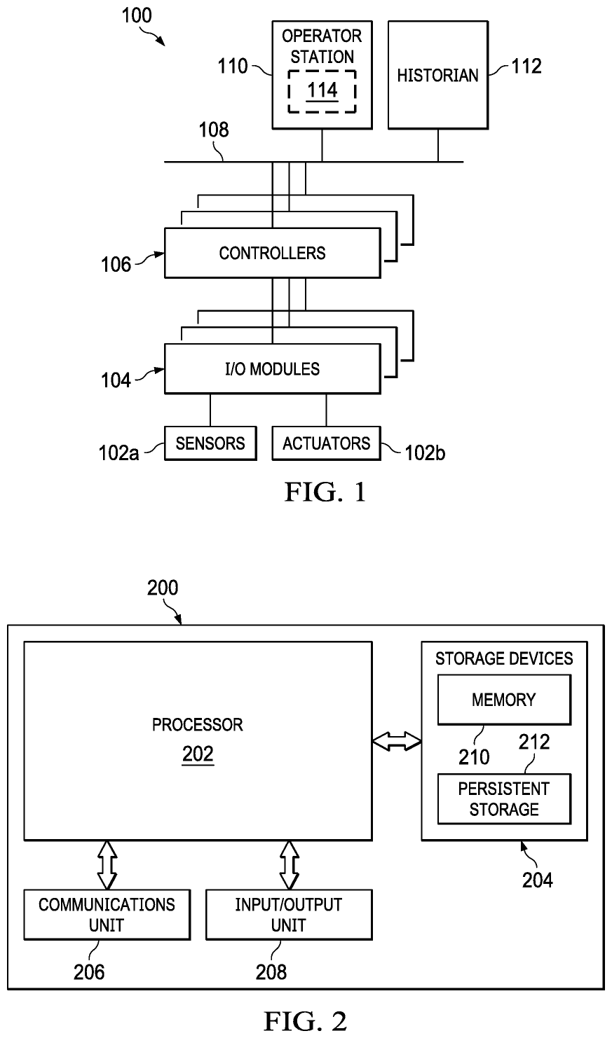

FIGS. 1 through 6G, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Embodiments of the present disclosure contemplate that an autonomous, data-driven health monitoring scheme can be at the core of a hierarchical predictive monitoring system or scheme. Such a health monitoring scheme uses data-driven modeling of linear and non-linear processes, as well as stationary and non-stationary processes. The health monitoring scheme can also have integrated functionalities for converting data to useful knowledge regarding conditions of the process or process equipment and for generation of fault alarms or key performance indicator (KPI) predictions for the process or process equipment (where KPIs represent key output monitoring signals). The health monitoring scheme can use a adaptive or learning algorithm to correct fault prediction based on user-friendly event management operations.

In such a health monitoring scheme, latent variable (LV) methodologies are fully exploited. As data obtained from most dynamic processes are time series data that are inherently related to each other or related to past histories of the processes, dynamic versions of principal component analysis (PCA) and partial least-squares (PLS) algorithms are utilized as the main tools for modeling and fault diagnosis. In addition, their nonlinear extensions by utilizing different kernel functions are also considered. In particular, Dynamic PCA or PLS (DPCA or DPLS) and Kernel PCA (an extension of PCA using techniques of kernel methods) or PLS (KPCA or KPLS) can effectively model most linear and nonlinear processes. The prominent advantages of PCA- and PLS-based methods are their ability to handle high dimensional processes by reducing data dimensionality, and their efficient computations as well as visualizations. However, these methods are designed to monitor stationary or quasi-stationary processes. In the real world, industrial processes under study cannot be characterized with stationary or quasi-stationary properties for various reasons, such as variations in multiple ranges of operations, which could be defined in terms of product specification(s) or feed composition or operating condition(s). Accordingly, industrial process monitoring using PCA and PLS methods is not a trivial task. Several challenges and practical constraints need to be tackled, which are the focus of this disclosure.

Most fault detection and predictive monitoring schemes include modeling and training based on normal data that can cover a wide range of operating conditions of the system, a residual/alarm generator and threshold evaluator based on selected error indices, output (KPI) estimation and prediction for trending and predictive maintenance, fault source isolation, and fault feature classification based on data collected under known or identified fault scenarios. Analytical redundancy based fault detection and diagnosis (FDD) methods rely on explicit analytical or regression models, whether known or constructed. The construction of analytical models involves great efforts, and errors and uncertainties are inevitable during the process. Moreover, current model-based FDD methods are still limited to system models of lower dimensions. When extended to a process with many inputs, outputs, and process variables, computation complexities for model-based FDD become incredibly high and accuracy suffers.

As noted above, the most distinctive feature of PCA and PLS methods is their ability to handle high-dimension problems. In these methods, the originally measured data structure, consisting of a number of correlated observable variables, is represented by a reduced number of latent variables that are found to cover the variations of the original data to the greatest extent. In traditional PCA and PLS methods, features and intrinsic relations among high-dimensional data observations are extracted and represented in the latent variable structure, mainly based on correlations among different variables. Singular value decomposition (SVD) can be performed to extract the principal components. However, in almost all dynamic systems, data (especially time-series data) are not only correlated to each other, but are also auto-correlated. Time correlation needs to be handled, which results in several improvements of the PCA and PLS methods, including several commonly used DPCA and DPLS algorithms. In these algorithms, the observable variables that are related in their delayed or lagged forms are “lifted” using an augmentation operation. Such an augmentation procedure in DPCA and DPLS directly embeds the dynamic interconnection of process variables into the monitoring scheme, which is similar to the autoregressive moving average (ARMA) structure of the process.

FIG. 1 illustrates a portion of an example industrial process control and instrumentation system 100 according to this disclosure. As shown in FIG. 1, the system 100 includes various components that facilitate production or processing of at least one product or other material. For instance, the system 100 can be used to facilitate control or monitoring of components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials or energy in different forms in some manner.

In the example shown in FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one input/output (I/O) module 104 is coupled to the sensors 102a and actuators 102b. The I/O modules 104 facilitate interaction with the sensors 102a, actuators 102b, or other field devices. For example, an I/O module 104 could be used to receive one or more analog inputs (AIs), digital inputs (DIs), digital input sequences of events (DISOEs), or pulse accumulator inputs (PIs) or to provide one or more analog outputs (AOs) or digital outputs (DOs). Each I/O module 104 includes any suitable structure(s) for receiving one or more input signals from or providing one or more output signals to one or more field devices. Depending on the implementation, an I/O module 104 could include fixed number(s) and type(s) of inputs or outputs or reconfigurable inputs or outputs.

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. These controllers 106 could interact with the sensors 102a, actuators 102b, and other field devices via the I/O module(s) 104. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent proportional-integral-derivative (PID) controllers or multivariable controllers, such as Robust Multivariable Predictive Control Technology (RMPCT) controllers or other types of controllers implementing model predictive control (MPC) or other advanced predictive control. As a particular example, each controller 106 could represent a computing device running a real-time operating system, a WINDOWS operating system, or other operating system.

Operator access to and interaction with the controllers 106 and other components of the system 100 can occur via various operator stations 110. Each operator station 110 could be used to provide information to an operator and receive information from an operator. For example, each operator station 110 could provide information identifying a current state of an industrial process to an operator, such as values of various process variables and warnings, alarms, or other states associated with the industrial process. Each operator station 110 could also receive information affecting how the industrial process is controlled, such as by receiving setpoints for process variables controlled by the controllers 106 or other information that alters or affects how the controllers 106 control the industrial process. Each operator station 110 includes any suitable structure for displaying information to and interacting with an operator.

A historian 112 is also coupled to the network 108 in this example. The historian 112 could represent a component that stores various information about the system 100. The historian 112 could, for example, store process variable history. The historian 112 represents any suitable structure for storing and facilitating retrieval of information. Although shown as a single centralized component coupled to the network 108, the historian 112 could be located elsewhere in the system 100, or multiple historians could be distributed in different locations in the system 100.

The system 100 therefore has sensors for determining a set of state variables, a plurality of defined control variables, and a plurality of measured or determined output variables, all defining the operation of the industrial process at any given time. These variables can be stationary variables, quasi-stationary variables or dynamic variables, or a combination of all three.

This represents a brief description of one type of industrial process control and instrumentation system that may be used to manufacture or process one or more materials. Additional details regarding industrial process control and instrumentation systems are well-known in the art and are not needed for an understanding of this disclosure. Also, industrial process control and instrumentation systems are highly configurable and can be configured in any suitable manner according to particular needs.

The system 100 can include an autonomous data-driven health-monitoring scheme. In accordance with this disclosure, at least one tool 114 is provided that can be used to pre-process data, perform data-driven modeling of linear and non-linear as well as stationary and non-stationary processes, perform fault detection and diagnosis, perform fault prediction, and the like, as will be further described below.

The tool 114 could be implemented in any suitable manner. For example, the tool 114 could be implemented using hardware or a combination of hardware and software/firmware instructions. In this example, one instance of the tool 114 is implemented on an operation station 110. However, any number of tools 114 could be implemented within a system, and the tool(s) 114 could be implemented using any suitable device(s). For example, as described below, a tool 114 could be implemented into each sub-component of any component of the plant. Additional details regarding the tool 114 are provided below.

Although FIG. 1 illustrates a portion of one example industrial process control and instrumentation system 100, various changes may be made to FIG. 1. For example, various components in FIG. 1 could be combined, further subdivided, rearranged, or omitted and additional components could be added according to particular needs. Also, while FIG. 1 illustrates one example operational environment in which the autonomous data-driven health-monitoring scheme could be used, this functionality could be used in any other suitable system.

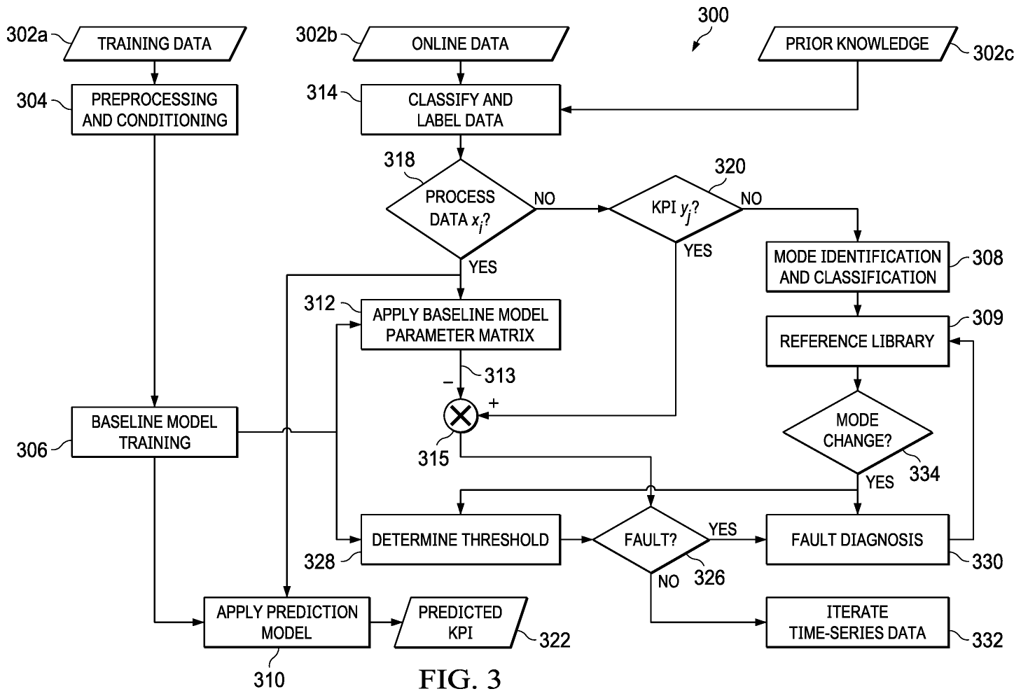

FIG. 2 illustrates an example device 200 for performing autonomous data-driven health monitoring in industrial plants according to this disclosure. The device 200 could, for example, denote the operator station 110 in FIG. 1 used to implement the tool 114. However, the device 200 could be used in any other suitable system, and the tool 114 could be implemented using any other suitable device.

As shown in FIG. 2, the device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry. The processor could, in some embodiments, autonomously perform the below described functions of the data-driven health monitoring system.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 could include at least one network interface card or wireless transceiver facilitating communications over at least one wired or wireless network. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device.

Although FIG. 2 illustrates one example of a device 200 for performing autonomous data-driven health-monitoring in industrial plants, various changes may be made to FIG. 2. For example, various components in FIG. 2 could be combined, further subdivided, rearranged, or omitted and additional components could be added according to particular needs. Also, computing devices come in a wide variety of configurations, and FIG. 2 does not limit this disclosure to any particular configuration of computing device.

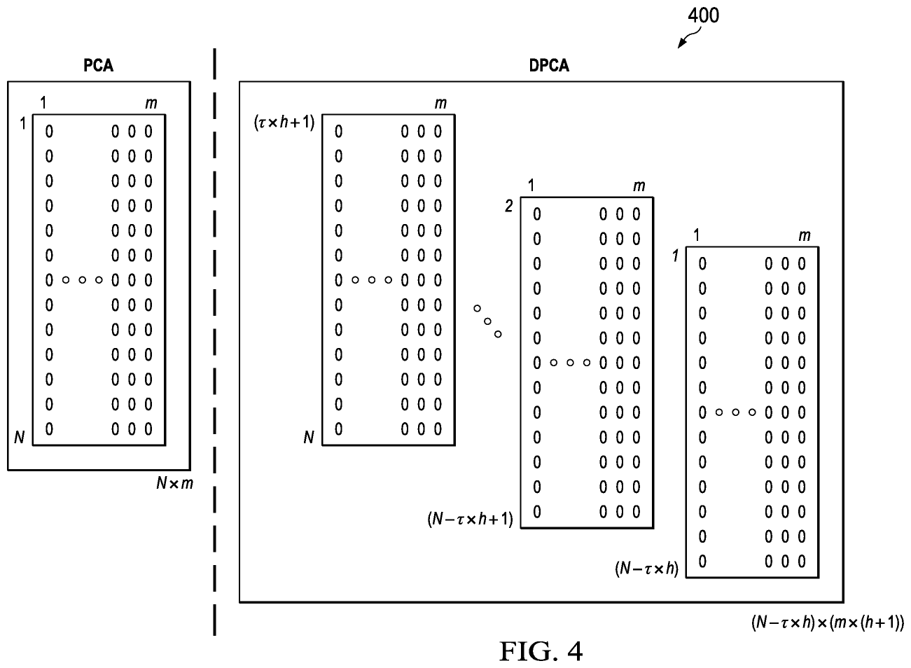

FIG. 3 illustrates a block diagram of an example autonomous data-driven predictive monitoring system 300 according to embodiments of this disclosure. The overall system is divided into a learning operation and a real-time operation. In the learning operation, data is examined and decisions are made, based on the data, as to what type of models should be used to continue processing and preconditioning the data. A model is then built and tested as part of the learning operation. After model determination and training, the trained model is used in a real-time fault detection and diagnosis operation (i.e., a real-time health monitoring operation) on preprocessed and preconditioned input data. This is followed by a fault diagnosis operation using the same model.

Several improved versions of PCA and PLS approaches are utilized in fault detection and performance monitoring that can handle both linear and nonlinear relations among data. At the same time, correlations and auto-correlations among time series are taken into consideration, for which the DPCA and DPLS are adopted. Therefore, in the scheme of this disclosure, DPCA, DPLS and their nonlinear extensions using different kernel functions are applied to generate alarms and to estimate process variables and KPI. There are some fundamental assumptions in the derivations of these approaches, and performance will suffer when the assumptions are not satisfied.

One challenge for almost all PCA and PLS methods is the assumption of stationary properties (e.g., constant mean and variance) of time-series data, which is rarely satisfied in real-world operations. If the data is determined to be non-stationary, a decomposition-based cascaded DPCA/KPCA approach can be used to isolate the non-stationary (or deterministic) component of the data. In this approach, a deterministic model, such as a first-principle model, or a parametric or non-parametric regression model, is applied to extract residual on the outputs (e.g., y-ŷ, where y is a KPI vector and ŷ is an estimated KPI vector), which contains noise and modeling errors and is considered to be quasi-stationary in the fault-free case.

This cascaded DPCA/KPCA approach involves the use of a baseline deterministic model (as trained and tested in a learning operation) at baseline model application stage 312. This baseline deterministic model is a predictive model that is operable to receive a data vector of the real-time preprocessed and preconditioned data xi, and to provide an estimated KPI vector ŷ.

The baseline deterministic model is constructed at baseline modeling step 306 from the historical data, after a preconditioning and preprocessing stage 304 that operates to determine parameters for processing the data in real time, as further described below. The output KPI vector is a function of the input vector, and the baseline deterministic model is operable, after training, to store a representation of the industrial process system represented by the historical training data, such that input data can be mapped through this stored representation to provide a prediction or estimation of KPI on the output. This baseline deterministic model can be a first-principle (if known), or a parametric or non-parametric regression model. During the learning operation, model selection is a data-driven decision. That is, depending on the characteristics determined in the preprocessing and preconditioning stage 304, different models can be selected. Depending upon the model selected, each model can have different versions or kernels. A model is selected at, for example, using default kernel and then trained and tested. The testing includes inputting the historical input data vector xi representing in part process variables of the system associated with the historical data set. This will provide an estimation or prediction of a KPI vector on the output of the model. The KPI vector associated with that input vector xᵢ in the historical database is then compared to the estimated KPI value, and a residual (or error) determined. Alternatively, the deterministic model can be realized and embedded in a dynamic observer or Kalman filter, which will provide better convergence and generate the estimated KPI output and the residual signal. Using this residual information, a determination can be made as to whether this is the lowest residual kernel available for that model. It may be that it is necessary to select different kernels and test each to make such a determination. After the determination, this model (and its training parameters) is set as the baseline deterministic model in this example.

In the real-time online (or live) operation, process input data 302b is received and preprocessed (using the preconditioning parameters determined at data classification and labeling stage 314, discussed further below) to precondition the received data. This preconditioned and preprocessed data is used in the learning operation, as described above, for subsequent processes to provide data-driven decisions as to the type of processes and models to be used for the health monitoring function and fault detection/analysis function. Once preprocessed in the learning operation, models are built at baseline modeling step 306 and a model selected as a baseline model at baseline model application stage 312, as described above and further below. This is the baseline model used in real-time fault detection and fault diagnosis operations.

In the real-time online operation, the estimated KPI value is provided at the output of baseline model application stage 312 from the baseline model on an output 313 as an estimated or predicted value. It is then input to subtraction block 315. The input KPI vector, after preconditioning and preprocessing, is extracted from the input preprocessed data vector at decision step 318. The preprocessed and preconditioned data vector xi is sent to baseline model application stage 312 and the KPI vector yⱼ is extracted and sent to the positive input of the subtraction block 315, via a decision step 320 that can extract non-process information (i.e., information as to operating conditions, etc.) from the input for further processing, as will be further described below. The output of the subtraction block 315 constitutes the residual (or error) between the expected or predicted KPI and the actual KPI. Accordingly, this process is operable to extract residual on the outputs, which mainly reflects noise and other random uncertainties. In some embodiments, the residual is a Hotelling statistic T² or a square prediction error (SPE) statistic.

Returning to the learning operation, first, the preprocessing (or conditioning) stage 304 performs several tests, operations, and calculations on training (or historical) data 302a to autonomously determine data characteristics, perform data segmentation, and determine key tuning parameters for DPCA and KPCA in this example. This reduces the requirement for input of operator knowledge (such as prior knowledge data 302c), therefore reducing the time and cost of applying the health monitoring scheme. The preprocessing stage 304 enables autonomous operations and improved performance of the subsequent online detection, diagnosis, and prediction by providing various preprocessing functions, as described below. The autonomous operations that are enabled include autonomous determination of fault detection methods (e.g., DPCA/KPCA based and the cascaded DPCA/KPCA) to be used given different data sets that represent linear or nonlinear and stationary or non-stationary time-series data. Additionally, the preprocessing is applied to the online data.

The preprocessing stage 304 includes signal delay estimation and linear regression model construction. The data matrix may contain process variables that are dynamically related and subject to time delays. Determination of the maximum delays among all variables can help choosing several important tuning parameters in the subsequent dynamic principle component analysis based modeling. There are several methods for estimating time delay between a pair of signals, ranging from the simplest cross-correlation based to the more sophisticated auto-regression exogenous (ARX) model or output error (OE) based approaches. The former usually requires less computations but suffers in accuracy, while the latter is more accurate but computationally expensive.

Most time-series data are either process variables xᵢ or KPIs yⱼ, collected from the dynamic system and process, and they are most likely dynamically related (i.e., time-correlated). In principle, these time-series data can be represented by a physical model or an experimental model, for example, an auto regression model such as an ARX or ARMAX (moving average) model can be created using the input and output data. Therefore, by using the ARX or OE (output error) approach, the complete set of parameters for a parametric regression model can be obtained as a by-product in addition to the time delay. Construction of such a model is different from construction of the DPCA model. To construct an accurate PCA or PLS model, mean centering is performed on both input and output data (and the mean centering, as one parameter, is retained for preprocessing data in the real-time operation). For this reason, the PCA/PLS-type models are mainly used for stationary or quasi-stationary processes. The parametric regression model is built upon the raw data and reveals the underlying dynamic relationship between input and output, hence it can be used to de-trend and remove the non-stationary component of the data to provide quasi-stationary data. The various approaches to estimating time delay between signals are described in further detail below.

The cross-correlation method of estimating time delay between signals is based on finding the maximum cross-correlation of two signals with respect to i, where i is the delay shift present in the output dataset, as follows:

$${delay}_{i} = {arg max}_{i} ( corr ( f ( t ) , y ( t - i ) ) ) .$$

In the coherence-based method of estimating time delay between signals, both of the signals are first transformed into frequency domain representations. Correlation in the frequency domain can then be calculated, and the single-side spectrum can be found. The estimated delay is then determined by, first, finding the frequency with the largest amplitude on the single-side spectrum and, second, finding the value where the magnitude-squared coherence has the largest (or the second largest) value. Finally, the delay is equal to the phase corresponding to the largest value (or second largest value) divided by 2πf. The phase angle can be found by calculating the cross power spectral density of datasets.

In the ARX model based method of estimating time delay between signals, the ARX model can be expressed as:

$$y ( t ) + {a}_{1} y ( t - 1 ) + … + {a}_{n} y ( t - n ) = u ( t - {n}_{k} ) + {b}_{1} u ( t - {n}_{k} - 1 ) + … + {b}_{n} u ( t - {n}_{k} - n ) + e ( t ) .$$

The ARX model can also be expressed as:

A(q)y(t)=B(q)u(t−nₖ)+e(t).

Where A(q), B(q) are polynomials of the delay operator q⁻¹ in the regression model:

A(q)=1+Σᵢ₌₁ⁿaᵢ·q⁻ⁱ, B(q)=1+Σⱼ₌₁ⁿbⱼ·q^{-j}.

Using the ARX model, the delay can be found by using the Least-Squares estimation to calculate the local minimum of the loss function in terms of nₖ:

delay=arg minₙ_{ₖ}(|y(t)−ŷ(t, nₖ)|²).

In the output error (OE) based method of estimating time delay between signals, the following model is used:

$$y ( t ) = \frac{B ( q )}{F ( q )} u ( t - {n}_{k} ) + e ( t ) .$$

Given the above model, suppose that the relation between input u and the undisturbed output y can be written as a linear difference equation, and the disturbances consist of white measurement noise. The delay is found by calculating the variance of the noise component e(t) for nₖ=1,2, . . . j, where nₖ corresponds to the lowest error variance:

delay=arg minₙ_{ₖ}(var(e(t,nₖ))).

This method is more computationally expensive. In some embodiments, each of the above methods of delay estimation is included in the system, and a user can easily choose which one to use depending on the application. It is understood that if a simple regression model is needed for the subsequent operations, it is recommended to use the ARX and OE approaches.

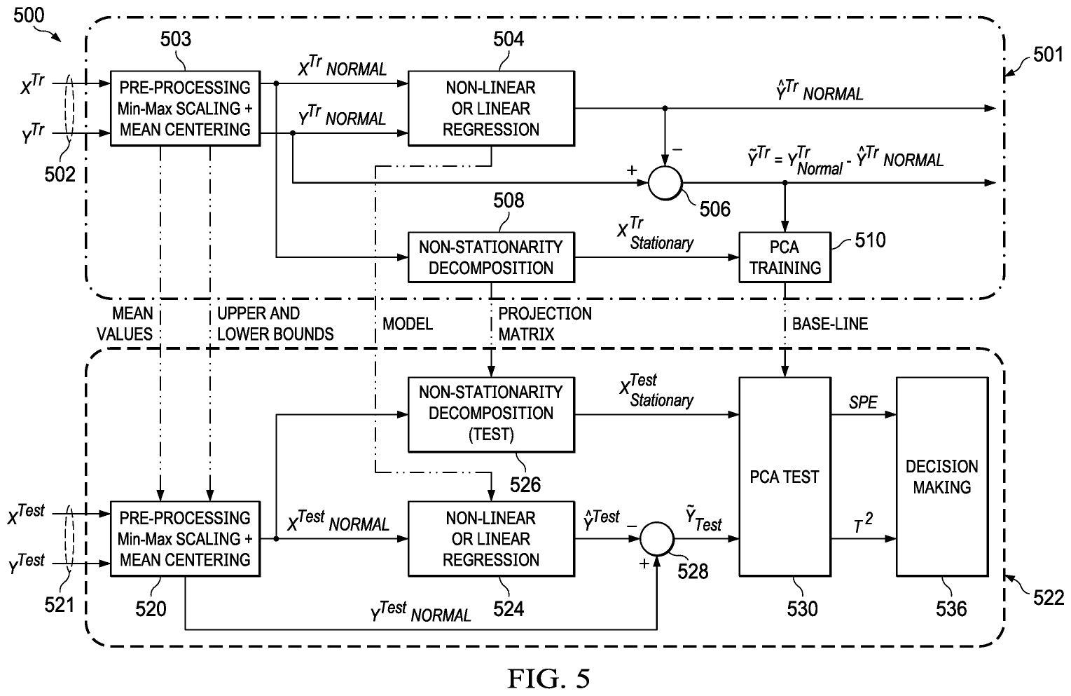

The preprocessing stage 304 additionally includes data conditioning by normalization and data matrix augmentation. Data normalization using min-max normalization (or scaling) is performed so that the scaled data can be used in DPCA/DPLS modeling. The primary goal for application of min-max normalization is to avoid the case when variables with high magnitudes and significant mean variations always become the primary predictors (principals). In other words, min-max normalization scales all variables into the interval of 0 and 1 to ensure that the variables' statistical feature is the determining factor for the principal direction. In DPCA, matrix augmentation is used to arrange signals with time-correlations in the data matrix by copying and shifting operation 400, as illustrated in FIG. 4. The augmentation parameters τ (unit lag) and h (number of shifts) for the DPCA algorithm can be autonomously chosen based on time-delay estimation.

The preprocessing stage 304 further includes testing of nonlinearity and non-stationarity for choosing different modeling methods (e.g., DPCA, KPCA, or cascaded DPCA/KPCA). By using the simple linear regression model for the input and output data, a test of nonlinearity and non-stationarity can be performed on the output residual error r=y-ŷ. Data-driven approaches, such as nonlinear correlation and surrogates-based methods are commonly adopted for the nonlinearity test, which have a simple extension to multi-input and multi-output cases. For example, one method is based on constructing a set of surrogate data that shares common linear properties of the actual data, such as auto- and cross-correlations. The non-stationary test can be performed by a hypothesis test, which is based on testing homogeneity of a set of evolutionary spectra evaluated at different instants of time. Kullback-Leibler divergence and log-spectra deviation can be used to measure the distance or dissimilarity between two spectra.

The preprocessing stage 304 also includes identifying a model based on raw data, which can include estimation of regression model parameters, model order, time constants, and delays among different time-series data (some of which is described above). The preprocessing stage 304 further includes calculation of tuning parameters for a DPCA and KPCA, and determination of non-linearity or non-stationarity of data, to be applied as described further below. In some embodiments, the preprocessing stage 304 also includes data resampling, missing data interpolation, mean centering, and variance normalization.

Once the preprocessing stage 304 has preprocessed and conditioned training data 302a, the results of preprocessing stage 304 are used to construct (or train) baseline models, such as DPCA/DPLS, cascaded DPCA/DPLS, and their non-linear extension based on KPCA/KPLS. This includes autonomous identification of a kernel function from a library such that the resulting KPCA/KPLS model has minimal residual.

In addition to the above-mentioned training data 302a, real-time process input (or online) data 302b and prior knowledge data 302c are also input into the monitoring system 300 in the real-time operation. For example, process input data 302b could come from sensors 102 of a plant in system 100, and prior knowledge data 302c could come from a historian 112 or could be entered by a user at an operator station 110 in system 100. As noted above, these data can be time-series data. These data are classified and labeled in the classification and labeling stage 314, which is able to parse the input information into one of several categories, such as process variables xᵢ, operating conditions, or KPIs yᵢ. The classified/labeled data is then fed into decision steps 318 and 320, which determine how the data is used based on its classification. If, at decision step 318, the data is process data (process variables denoted as xᵢ), then it is fed as an input vector into the baseline model application stage 312, further discussed below. If the data is not process data, then it proceeds to decision step 320, where, if the data is KPI data (denoted as yⱼ), then it is used with the output of the baseline model application stage 312 to determine residuals by comparing the actual KPI with the estimated or predicted KPI in the subtraction block 315. If the data is not KPI data, it can be assumed, in some embodiments, that the data is operating condition information, which can be used by the mode identification and classification step 308, as described further below.

In the real-time monitoring operation, the residual is analyzed at decision block 326 to compare the residual to a threshold determined at step 328 in order to detect faults. The threshold can be defined in the learning stage as a function of the data, or the user can determine the fault detection/diagnosis operation to be performed. This information can be embedded in the input condition information (i.e., non-process input information) that is parsed from the input data. For example, the non-process information can define mode identification and classification operations in mode identification and classification step 308, which selects a process to initiate some fault diagnosis program. A reference library 309 can be accessed and used to set the thresholds or, alternatively, the thresholds can be set in the learning operation. If set in the learning operation, these thresholds can be changed in the fault diagnosis step 330.

If the thresholds for fault detection are set during the learning operation, they are set based on the known residuals associated with the trained and tested baseline model. Knowing the acceptable range of residuals in the trained baseline model from baseline modeling step 306, the fault detection thresholds can then be determined and set at step 328. This can also be data-driven.

After a fault decision has been made at the decision block 326, the operation then proceeds to fault diagnosis step 330, as described below. In this step, one goal is to isolate and assign a health index value to each of the process variables. To facilitate this, each process variable is isolated from the data, and then the data is processed through the baseline model application stage 312 to determine the residual, which is again evaluated for faults at decision block 326. This is repeated for each process variable. Once the operation is complete, the time series data is iterated to the next step and the process repeated at a step 332.

In the case that the fault diagnosis step 330 indicates that a mode change is required, the information can be updated in the reference library 309. Also, information input to the process in mode identification and classification step 308 can indicate a mode change. Such indications are determined at decision block 334, and a determination of a mode change can cause new thresholds to be set at step 328 and possibly even cause alternate fault diagnosis procedures to be used in step 330.

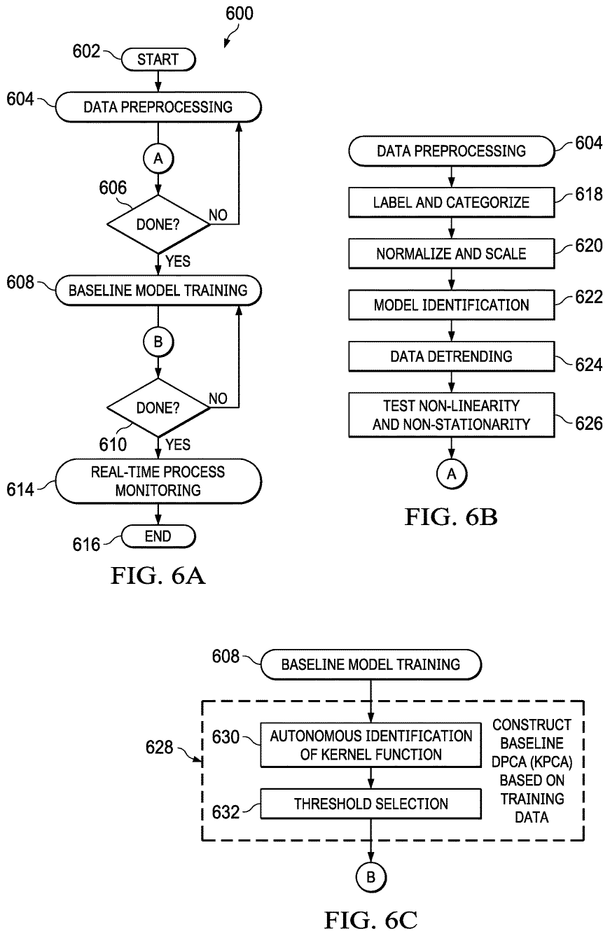

The baseline model application stage 312 can, in some embodiments, include using the cascaded DPCA/KPCA approach to apply a decomposition-based cascaded approach to decompose the process input data (or online data) 302b into quasi-stationary and non-stationary components. FIG. 5 illustrates an example block diagram of a decomposition-based cascaded approach 500. This embodiment represents the portion of the operation associated with fault detection based on data collected from a variety of systems/processes. This data, as described above, is comprised of data sets obtained from dynamic systems which are represented as multivariate time series, or from stored historical data. One aspect of this cascaded approach is to isolate the non-stationary (deterministic) portion of the data. Initially, the system needs to be trained based on the data in a data-driven operation. Training data is retrieved from a historical data store and is input on input 502 for one time interval as training data X^{Tr} and Y^{Tr}, which is processed through a preprocessing operation 503. Preprocessing operation 503 processes the training data in accordance with the preprocessing algorithm described above with respect to preprocessing stage 304, and outputs preprocessed data X^{Tr}ₙₒᵣₘₐₗ and Y^{Tr}ₙₒᵣₘₐₗ. This preprocessing is applied in both the learning (or training) operation 501 and during online operation 522. In the learning operation 501, this preprocessing operation will determine min-max scaling and mean centering based on the data in an autonomous operation, and this is passed on to the preprocessing block (online preprocessing block 520) in an online operation 522.

The output X^{Tr}ₙₒᵣₘₐₗ of the preprocessing operation 503 is then input to a non-linear or linear regression model 504, which is to be defined in the learning operation 501. The linear regression model 504 defines the baseline model described above with reference to baseline model application stage 312. This baseline deterministic model is derived from the data preconditioning, preprocessing and model building steps described above. As described above, this is a first-principle (if known) or parametric or non-parametric regression model.

Referring further to FIG. 5, the non-linear or linear regression model 504 is operable to output an estimated KPI value that is subtracted in a subtraction block 506 (similar to the subtraction block 315) from the input KPI value Y^{Tr}ₙₒᵣₘₐₗ to provide a residual value on the output of the subtraction block 506. In addition, the value X^{Tr}ₙₒᵣₘₐₗ output from the preprocessing operation 503 is provided as an input to a non-stationary decomposition block 508, which decomposes the processed input signal X^{Tr}ₙₒᵣₘₐₗ into quasi-stationary and non-stationary components. This is facilitated by a first non-stationary decomposition algorithm.

In this first non-stationary decomposition algorithm, as an initial step, a covariance matrix Q of the normalized process input X^{Tr}ₙₒᵣₘₐₗ is determined as:

Q=(1/(N−1))(X^{Tr}ₙₒᵣₘₐₗ)^{T}(X^{Tr}ₙₒᵣₘₐₗ).

Next, the non-stationary decomposition algorithm proceeds as follows:

| | |
|---|---|
| I. | Conduct Singular Value Decomposition (SVD) on Q: Q = U S U^{T} |
| II. | For i = 1, determine the matrix p as pᵢ = X^{Tr} ₙₒᵣₘₐₗ U(:, 1:i) |
| III. | Determine pᵢ₋₁ by shifting pᵢ backward |
| IV. | Calculate Φᵢ = (pᵢ₋ₗ pᵢ₋ₗ^{T})* pᵢ₋ₗ^{T} pᵢ, where * is the pseudo-inverse |
| V. | Obtain eigenvalues E = {e₁ ... ... eᵢ} = eig(Φᵢ) |
| VI. | if ej ≥ 0.95, j = 1 ... i, then |
| | iterate i (i = i + 1) and go to step II |
| | else |
| VII. | Stop the For loop |
| VIII. | End the If loop |
| IX. | End the For loop |
| X. | Determine regression matrix Γ = (p^{T} p + λ I′)* p X^{Tr} ₙₒᵣₘₐₗ |
| XI. | Decompose X^{Tr} ₙₒᵣₘₐₗ as: X^{Tr} _{stationary} = X^{Tr} ₙₒᵣₘₐₗ − Γ p |

In this example, I′ is the regularization term in the normalization equation for finding the regression matrix Γ. Therefore, I′ is similar to the identity matrix except that the first element (i.e. the top left corner element) is zero.

In addition to providing the quasi-stationary value X^{Tr}_{stationary}, the non-stationary decomposition block 508 is operable to provide a projection matrix to an associated online non-stationary decomposition block 526 in the online operation 522 to parameterize the non-stationary decomposition block 526 for the online analysis, which is another operation that is data-driven.

The stationary value X^{Tr}_{stationary} and the residual value are both input into a PCA training block 510. Thus, the non-stationary decomposition block 508 removes the non-stationary portions of the data, yielding only the stationary portions, which are then utilized in conjunction with the residuals for PCA training of the models in the off-line mode. This represents the dynamic versions of the principal component analysis (PCA) algorithm, and possibly a partial least-squares (PLS) algorithm, as the main tool(s) for modeling and fault diagnosis. This in turn is used to parameterize an online PCA test block 530 for the fault diagnosis operation in the online operation 522 with baseline information.

In online-line mode or operation 522, test data X^{Test} and Y^{Test} are input on input 521 to the online preprocessing block 520, which was parameterized with the mean values and the upper and lower bounds for the data from the preprocessing operation 503 in the training or learning operation 501. The online preprocessing block 520 provides as outputs X^{Test}ₙₒᵣₘₐₗ. Preprocessed value X^{Test}ₙₒᵣₘₐₗ is then input to a non-linear or linear regression model 524, which is the model determined to be the best model to use as a function of the preprocessing operation 503 in the learning operation 501 described above. In addition, the step in the learning operation 501 that defines the model in linear regression model 504 based on the data also defines the mode of operation for the model in linear regression model 524.

The value X^{Test}ₙₒᵣₘₐₗ is also input to a non-stationary decomposition block 526, which is the same as the non-stationary decomposition block 508, and is parameterized thereby. The output of the non-stationary decomposition block 526, operating in accordance with the first algorithm as described above, outputs a test value of X^{Test}_{stationary}, and the output of the non-linear or linear regression model 524 outputs an estimated KPI value, which is input to a subtraction block 528 for subtraction from the value Y^{Test}ₙₒᵣₘₐₗ to provide the residual KPI value. The output values from the decomposition block 526 and the subtraction block 528 (the residual) are input to a PCA test block 530 in order to test for faults by processing the inputs through a statistical algorithm, such as a conventional SPE or T² statistic, described below. The below equations associated with these statistical evaluations determine the contribution of each process variable to the combined health index. This is facilitated in a decision-making block 536.

Returning to FIG. 3, baseline model application stage 312 using the cascaded DPCA/KPCA approach applies the DPCA or KPCA procedure to the determined quasi-stationary input and the stationary output residuals for fault detection and diagnosis. This can include, for example, subtracting KPI data from the output of the baseline model application stage 312 in order to determine a residual (which represents a difference, or error, between the actual KPI data Y and the estimated KPI data and the estimated KPI data Ŷ). In other embodiments, for example when the process input (or online) data 302b is stationary, other models can be used to determine output residuals for fault detection and diagnosis.

The monitoring system 300, utilizing the embodiment described in FIG. 5 of the present disclosure, is also capable of recognizing faulty process variables and subsequently isolating the fault source. This is done by determining a contribution score of each process variable in a health/performance index. The contribution scores are further compared with the health index and a threshold to determine the process variables that have the largest contribution to generation of a faulty health index. Consequently, the health monitoring scheme provides information for the operator to isolate the source of fault and further adopt a proper precautionary course of action.

In some embodiments, the health monitoring scheme uses a reconstruction-based contribution (RBC) method to determine the contribution score of the process variables at every epoch of time, which ensures that the variable with the highest score has the most contribution to the faulty health index. In calculating RBC for each process variable, it is iteratively assumed that each process variable is the source of the fault, and consequently that process variable is removed from the health index calculation and the improvement of the health index is inspected. This process is repeated iteratively for all process variables and scores are assigned to each variable with respect to the level of improvement induced when each one is removed from the health index. That is, if the variable with maximum RBC score is subtracted from the health index, the maximum improvement to the magnitude of the health index will result. The following equations show the generic contribution score calculation for a given test data set x ∈ R^{m} with regards to a combined index correlation matrix φ.

$${RBC}_{i} = \frac{{( {ζ}_{i}^{T} φ x )}^{2}}{{φ}_{ii}} , i = 1 , … , m$$

where ζᵢ is the i^{th} column of Iₘ, which is an m×m identity matrix, and x=[x₁, x₂, . . . , xₘ]^{T} is the new test data vector.

The above equations determine the contribution of each process variable to the combined health index. Furthermore, determining the contribution score of variables to a conventional squared prediction error (SPE) or Hotelling's T² fault detection statistics only requires substituting the φ matrix with the corresponding correlation matrix for the index of interest. In general, the above equations provide contribution scores for process variables if the process is linear or co-linear. In the case of a non-linear process, when a state-of-the-art method, such as KPCA, is utilized to generate the health index, a contribution rate plot is applied to find the contribution of variables to the corresponding health index, as follows:

$$K = ( {I}_{n} - ( 1 / n ) {1}_{n} {1}_{n}^{T} ) {K}_{raw} ( {I}_{n} - ( 1 / n ) {1}_{n} {1}_{n}^{T} )$$

$${K}_{new} = ( {I}_{n} - ( 1 / n ) {1}_{n} {1}_{n}^{T} ) ( {K}_{raw}^{new} - ( 1 / n ) {K}_{raw} {1}_{n} ) \\ ϕ = {K}_{new}^{T} {ΩK}_{new} + \frac{K ( {x}_{new} , {x}_{new} )}{{δ}_{rr}}$$

Where K is the kernel inner product operator in the feature space and K_{raw} is the direct map kernel matrix. 1ₙ ∈R^{1×n} is a vector in which all elements are one and Iₙ is the identity matrix. δᵣᵣ=gx_{h,a}² where h=var(Qᵣ) is the control limit for the combined index. The following equation shows calculation of the contribution rate plot:

$$C ( {x}_{new} , i ) = \vert \frac{- ( 2 / n ) {\sum }_{j = 1}^{n} {x}_{new , i} ( {x}_{new , i} - {x}_{j - i} ) K ( {x}_{new} , {x}_{j} )}{{δ}_{rr}} + trace ( \frac{\partial ( {K}_{new} {K}_{new}^{T} )}{\partial {v}_{i}} {\vert}_{v = {1}_{n}} Ω ) \vert$$

Where trace(.) is the trace of the matrix and other parameters are as follows:

$$Ω = \frac{{U ( {T}^{T} KU )}^{- 1} {Q}^{T} {Q}_{y} {A}_{y}^{- 1} {Q}_{y}^{T} {Q ( {U}^{T} KT )}^{- 1} {U}^{T}}{{δ}_{y}} - \frac{2 {T ( {U}^{T} KT )}^{- 1} {U}^{T} - {U ( {T}^{T} KU )}^{- 1} {T}^{T} {KT ( {U}^{T} KT )}^{- 1} {U}^{T}}{{δ}_{rr}} - 2 \{ \frac{( I - {TT}^{T} ) {W}_{r} ( {W}_{r}^{T} ( I - {TT}^{T} ) - {W}_{r}^{T} ( I - {TT}^{T} ) {KT ( {U}^{T} KT )}^{- 1} {U}^{T} )}{( {δ}_{rr} )} - \frac{\begin{matrix}{U ( {T}^{T} KU )}^{- 1} {T}^{T} K ( I - {TT}^{T} ) {W}_{r} ( {W}_{r}^{T} ( I - {TT}^{T} ) - \\ {W}_{r}^{T} ( I - {TT}^{T} ) {KT ( {U}^{T} KT )}^{- 1} {U}^{T} )\end{matrix}}{{δ}_{rr}} \} + \frac{\begin{matrix}{( {W}_{r}^{T} ( I - {TT}^{T} ) - {W}_{r}^{T} ( I - {TT}^{T} ) {KT ( {U}^{T} KT )}^{- 1} {U}^{T} )}^{T} {W}_{r}^{T} ( I - {TT}^{T} ) \\ K ( I - {TT}^{T} ) {W}_{r} ( {W}_{r}^{T} ( I - {TT}^{T} ) - {W}_{r}^{T} ( I - {TT}^{T} ) {KT ( {U}^{T} KT )}^{- 1} {U}^{T} )\end{matrix}}{( {δ}_{rr} )}$$

$$\frac{\partial {( {K}_{new} {K}_{new}^{T} )}_{p , q}}{\partial {v}_{i}} {\vert}_{v = {1}_{n}} = - \frac{2}{c} ( {k}_{new} ( p ) {k}_{new}^{raw} ( q ) {x}_{new , i} ( {x}_{μ , i} - {x}_{new , i} ) + {k}_{new} ( q ) {k}_{new}^{raw} ( p ) {x}_{new , i} ( {x}_{μ , i} - {x}_{new , i} ) ) + \frac{1}{nc} ( {k}_{new} ( p ) + {k}_{new} ( q ) ) {x}_{new , i} {\sum }_{k = 1}^{n} ( {x}_{k , i} - {x}_{new , i} ) {K}_{new}^{raw} ( k )$$

Where c is the kernel parameter and R=Φ^{T}U(T^{T}KU)⁻¹. The following are the rest of the parameters in the above equations:

$$\{ \begin{matrix}Φ = \hat{Φ} + {Φ}_{r} = {TP}^{T} + {Φ}_{r} \\ Y = \hat{Y} + {Y}_{r} = {TQ}^{T} + {Y}_{r}\end{matrix}$$

| Index | Calculation | Control limit | Expression |
|---|---|---|---|
| T_{y}² | t_{ynew}^{T}Λ_{y}⁻¹t_{ynew} | δ_{y} | $\frac{{A}_{y} ( {n}^{2} - 1 )}{n ( n - {A}_{y} )} {F}_{{A}_{y} , n - {A}_{y} , {x}^{a}}$ |
| Qᵣ | ∥ϕᵣᵣ(X_{new})∥² | δᵣᵣ | gχ_{h,}²ₐ^{b} |
| Tₒ² | t_{onew}^{T}Λₒ⁻¹t_{onew} | δₒ | $\frac{{A}_{o} ( {n}^{2} - 1 )}{n ( n - {A}_{o} )} {F}_{{A}_{o} , n - {A}_{o} , x}$ |
| Tᵣ² | t_{rnew}^{T}Λᵣ⁻¹t_{rnew} | δᵣ | $\frac{{A}_{r} ( {n}^{2} - 1 )}{n ( n - {A}_{r} )} {F}_{{A}_{r} , n - {A}_{r} , x}$ |

^{a}F-distribution with A_{y} and n−A_{y} degrees of freedom.
^{b}g · h = mean(Qᵣ), 2g² · h = var(Qᵣ).

Obtain K and Y

(1) After KPLS model: T = KU(T^{T}KU)⁻¹
(2) Run eigenvector decomposition on Ŷ: T_{y} = ŶQ_{y} = TQ^{T} Q_{y}
(3) Perform eigenvector decomposition on (1/n) Kₒ to get the eigenvectors
Wₒ with regard to its largest Aₒ eigenvalues. Tₒ = KₒWₒ^{a}
(4) Perform eigenvector decomposition on (1/n)Kᵣ to get the eigenvectors
Wᵣ with regard to its largest Aᵣ eigenvalues. Tᵣ = Kᵣ Wᵣ^{b}
^{a}Kₒ = (1ₙ−T_{y}(T_{y}^{T}T_{y})⁻¹T_{y})TT^{T}KTT^{T}(1ₙ−T_{y}(T_{y}^{T}T_{y})⁻¹T_{y}).
^{b}Kᵣ = (1ₙ−TT^{T})K(1ₙ−TT^{T}).

Returning to FIG. 3, the autonomous data-driven predictive monitoring system 300 can, in some embodiments, incorporate multimode process monitoring using mode identification and classification step 308. Most data-driven modeling and monitoring methods, e.g. DPCA/DPLS methods, treat the process under study as if it operates under a single operation mode. Performance of the DPCA/DPLS methods is significantly affected by variations in operating conditions, (e.g., variation in the variable means and their underlying relationship). Therefore, if a process is subjected to set-point changes or other types of mode variations, application of DPCA/DPLS on the training data for the purpose of generating a baseline model using a single mode assumption for fault detection purposes leads to erroneous results (e.g., false alarms). Identifying modes and classifying them can remedy this issue. After identifying and classifying modes, different baseline and nominal means can be identified for each mode. In a real-time monitoring sequence, the measured data can be clustered into one of the identified modes and a corresponding baseline model selected from the available library is used for generating residual signals for fault detection.

Multimode process monitoring further includes mode identification for the input data. There are several approaches for autonomous mode identification, such as Bayesian Gaussian mixture analysis, mixture principal component analysis, and K nearest neighbor methods. Each of these methods utilizes a specific criterion (a statistical feature) for identifying the dominant modes and ignoring the transition modes.

Multimode process monitoring further includes mode classification. Mode classification uses a key feature for classifying (or categorizing, or labeling) the data into different clusters. This feature depends on the nature of the industrial process in question. For instance, if the process variables are stationary in all the process modes, the mean and variance of the process data can be the key feature useable for generating Gaussian mixture models. In embodiments where the relationship between process variables is subject to change in different operation modes, a different baseline model can be identified corresponding to each different operation mode and, thus, a different baseline model can be defined in the baseline model application stage 312 and the linear regression model 504 for processing of data.

After identification of dominant modes in offline training, the mode classification process classifies the unlabeled online measurement data (i.e., test data or process input data 302b) into one of a set of identified modes stored in a mode registry. This classification can be based on the given key feature described above. For example, Mahalanobi's distance can be utilized to determine the weight contribution of each identified mode corresponding to the new test data. Thus, measured data can be clustered into one of the pre-identified modes. In some cases, it is possible that a new process mode exists in the test data that was not identified in the training step. In this case, the new mode needs to be detected and the mode registry should be updated.

The autonomous data-driven predictive monitoring system 300 also performs a prediction step 310 to predict output KPIs to guide actions from the drill down analysis view, which is based on a brute-force approach to predict the magnitude as well as the trend of the health index, and the corresponding contribution scores of the faulty process variables, based on which a user can finally determine when the process reaches a critical condition or what type of actions need to be taken based on predicted future trends.

Prediction of the output KPIs is also referred to as forecasted value ahead of time. For prediction, two horizons are determined. First, the prediction horizon wₚ, and second, the learning horizon wₗ. To determine the prediction horizon, the scheme first predicts the manipulated input variables that are utilized for predicting the KPIs. For that purpose, a brute-force algorithm is chosen from among many different time series modeling (TSM) techniques to find the nearest neighboring traj ectory.

In the brute-force algorithm, a fitting vector function and a fictitious matrix (the design matrix) are first defined. Examples of a fitting vector and a design matrix are shown as follows:

$$f ( k ) = [ \begin{matrix}1 \\ k \\ {k}^{2}\end{matrix} ]$$

$${D}_{k : k + {w}_{p}} = [ \begin{matrix}1 & … & k + {w}_{p} \\ ⋮ & ⋱ & ⋮ \\ {k}^{2} & … & {( k + {w}_{p} )}^{2}\end{matrix} ] .$$

The above vector function f (k) is one choice for the second order polynomial, which resembles the motif of the time-series within the prediction horizon. For example, if the process is observed to be periodic, a sinusoidal term may also be considered in f (k) as follows:

$$f ( k ) = [ \begin{matrix}1 \\ k \\ {k}^{2} \\ sin ( 2 π fk )\end{matrix} ]$$

$${D}_{k : k + {w}_{p}} = [ \begin{matrix}1 & … & k + {w}_{p} \\ ⋮ & ⋱ & ⋮ \\ sin ( 2 π fk ) & … & sin ( 2 π f ( k + {w}_{p} ) )\end{matrix} ] .$$

Moreover, if the variation of the manipulated variables is only a mean change (i.e. a piece-wise constant change), the scheme can choose f(k)=[1]. If the variation of the variables has a ramp trend, a better choice would be f (k)=[1, k]^{T}. If variables behave as a higher order polynomial, the scheme can increase the power of sample k in the function.

Once the fitting vector function f (k) and the design matrix are chosen, the prediction step 310 begins a learning (or training) procedure. Considering the current sample time to be k, the local model prediction matrices β_{X} and β_{Y} can be calculated using temporal data starting from (k−wₗ) to k as follows:

β_{X}=X(k−wₗ:k)D_{k-w}_{ₗ}_{:k}*

β_{Y}=Y(k−wₗ: k)D_{k-w}_{ₗ}_{: k}*

Next, the transformation matrix connecting β_{X} and β_{Y} is defined as T=β_{Y}β_{X}*, where * is the pseudo-inverse. Prediction can now be performed. At the k−th sample, both process variables X_{predicted} and Y_{predicted} (i.e., predicted KPIs 322) are calculated for wₚ samples ahead of time as follows:

X_{predicted}(k+1:k+wₚ)=β_{X}D_{k:k+w}_{ₚ}

Y_{predicted}(k+1:k+wₚ)=T X_{predicted}(k+1:k+wₚ).

As mentioned above, one of the important factors affecting the accuracy of the prediction is the correct choice of the fitting vector function f(k). In theory, the scheme would simply choose an appropriate function based on the available prior information regarding the process variations. However, in reality, the process variables are subject to a variety of changes, and accordingly a more general procedure is needed for more accurate prediction. One procedure for improved prediction can be performed using the following steps by integrating a shape detection algorithm in the above prediction algorithm.

First, find the nearest trajectory that fits the current set of data representing process variables. Second, detect distinctive shapes or motifs of the current trajectory and the predicted trajectory and then construct the fitting vector function f(k) by selecting the functions that represent the shapes, e.g. polynomial terms for ramp, parabola, cubic, etc., and sinusoids. Third, repeat the above-described brute-force prediction algorithm.

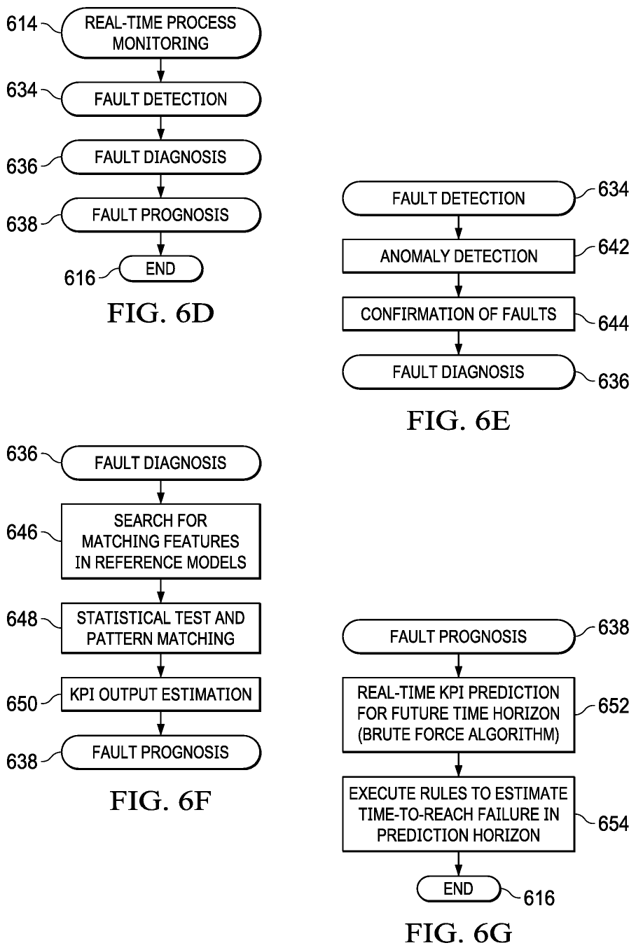

Referring now to FIGS. 6A-6G, there are illustrated flowcharts depicting an example operational method 600 for the data-driven predictive monitoring system. In some embodiments, the method 600 describes a method of operation of the autonomous data-driven predictive monitoring system 300. Accordingly, elements of FIGS. 6A-6G are described with reference to elements of the above FIGS. 3-5. However, it is understood that the method 600 could work with any appropriate predictive monitoring system.

Referring to FIG. 6A, there is illustrated a flowchart of an example top level operational flow of the method 600, wherein the method 600 initiates at a Start block 602 and proceeds to data preprocessing block 604 to perform data preprocessing on the data, as described above. This is a data preprocessing and conditioning step that is designed to clean the noise or unworthy components of the process variables. It also preconditions the time-series signal and extracts signal features for tuning purposes.

At decision block 606, the method determines if the data processing operation is complete and, if so, the method flows to baseline model training block 608 and performs baseline model training to define the baseline model, as described above, based upon the data preprocessing step. The method then flows to decision block 610, and determines if the model training has completed. If so, the method flows to real-time process monitoring block 614 and performs real-time process monitoring, as described above. The program then flows to an End block 616 and terminates.

Referring now to FIG. 6B, there is illustrated a flowchart of the data preprocessing block 604. When initiated, time-series multivariate data is received and the method flows to block 618 in order to label and categorize the data, as described above. In this step, the data can be classified into several categories. It can be categorized as process variables, operating conditions, or KPIs. The method then flows to block 620 wherein the data is normalized and scaled. The method then flows to block 622 wherein model identification is performed based on broad data. In this model identification process, an estimation of regression model parameters, time constants and process delays is performed. The method then flows to block 624 where data de-trending is performed. In this step, global or local deterministic trends are removed among different process variables. Additionally, the non-stationary time-series of the process is decomposed to recover quasi-stationary data. The method then flows to block 626 in order to test the non-linearity and the non-stationarity of the data. The method then flows to the next operation, the baseline model training block 608 in FIG. 6A, after passing the decision block 606.

Referring now to FIG. 6C, there is illustrated a flowchart for the baseline model training block 608 the program flows to a block 628 in order to construct the baseline DPCA (and that their nonlinear extension based on KPCA) and DPLS models, all based on training data, as described above. For this purpose, the sub-steps of blocks 630 and 632 are carried out. The first step is illustrated in block 630, where the model parameters are identified by autonomous identification, i.e., the time constant and the order of process are identified in the off-line preprocessing stage. In the next step, as illustrated by block 632, a threshold selection is made. In this step, different modes are also identified/classified based on their definition (e.g., dynamic relationship variations among process variables and variables that are considered as KPI outputs) using one of the following methods: i) data classification using K-means or other advanced classifiers; ii) principal component analysis-based classification or iii) system model and process knowledge based methods. The method then flows to the next operation, the real-time process monitoring block 614 in FIG. 6A, after passing the decision block 610.

Referring now to FIG. 6D, there is illustrated a flowchart of the real-time process monitoring block 614, which flows first to block 634 to perform a fault detection operation (described further with respect to FIG. 6E), then to block 636 to perform a fault diagnosis operation (described further with respect to FIG. 6F) and finally into block 638 to perform a full prognosis operation (described further with respect to FIG. 6G). The method then flows to End block 640.

The fault detection operation is illustrated in FIG. 6E. The first step is depicted at block 642, and includes detecting anomalies based on the residual signal, such as T² and SPE from DPCA. In a next step at block 644, an operation is performed to confirm a fault based on rules that have been pre-configured for such confirmation.

The fault diagnosis operation 636 as depicted in FIG. 6F. The first step is depicted in block 646, and includes performing a search for matching features in stored reference models. The next step is depicted in block 648, where statistical tests and pattern matching are performed. Next, at block 650, an output estimation of the KPI values is performed. This can utilize: i) DPCA/DIPLS based estimation; ii) Gaussian process regression; iii) Kernel PCA/PLS based estimation or iv) Loess regression.

The fault prognosis operation is illustrated in FIG. 6G. The first step is depicted in a block 652, where a real-time prediction is made using the data to determine a prediction of the KPI value over a future time horizon. This can be done using an ordinary brute-force algorithm or the improved brute-force algorithm described above. The next step, illustrated in block 654, executes rules to estimate time-to-reach-failure in the prediction horizon. After block 654, the method flows to the End block 616 and the method 600 is terminated.

In a system such as system 100, there are typically multiple functions in an equipment or unit to be monitored for faults. By organizing the functions described above in a hierarchical (multi-layered) structure, a mechanism to group and create logical data-based models to achieve early fault detection and root cause diagnosis can be achieved. In one example, the above functions are grouped into three levels. At level 0, fault detection is performed using an overall health index. At level 1, fault isolation is performed. That is, variable labeling based on user input on a fault that was detected at level 0. For example, SPE (sensor faults), T² (process faults), or RBC can be performed at this level. At level 2, the system builds dynamic hierarchical rules using fuzzy logic or a decision tree based on features and user input so that subsequent fault detection could be a useful actionable fault detection. At level 3, the system uses a user input reason code to refine reasoning.

Similarly, each piece of equipment can be conceptually broken down to constituent functions, and any of the above-described monitoring can be performed at the level of a specific function of a piece of equipment. For example, a distillation column could be broken down into a separation function, a condensation function, a material balance function, a reboiler function, a pressure/temperature profile function, and a V-L equilibrium function.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
in a learning and preprocessing operation:
autonomously analyzing, by a processor, historical data to determine data characteristics of the historical data and preconditioning settings for the processor to provide preprocessed historical data, the historical data including process variable and key performance indicators (KPIs) associated with a process,
providing a plurality of models, each associated with different determined data characteristics,
after determining the data characteristics of the historical data, selecting one of the plurality of models in a data driven selection process, and
training the selected model with the preprocessed historical data to define a baseline model; and
in a real-time operation:
preprocessing real-time data parameterized with the preconditioning settings,
applying the baseline model to the preprocessed real-time data to determine existence of faults to determine an overall health index for select process variables,
diagnosing and isolating, from the select process variables, faulty process variables determined to contribute to the health index, and
predicting a trend, a magnitude of the health index, and a contribution thereto of the faulty process variables.

2. The method of claim 1, wherein the learning and preprocessing operation is operable to clean noise or unworthy components of process variables, and to precondition and extract signal features for tuning purposes.

3. The method of claim 2, wherein the learning and preprocessing operation further includes labeling and categorizing the historical data or real-time data into process variables, operating conditions, and KPIs.

4. The method of claim 2, wherein the learning and preprocessing operation further includes normalizing and scaling the historical data or real-time data.

5. The method of claim 2, wherein the learning and preprocessing operation further includes selecting the one of the plurality of models in an identification step based on raw data estimation of at least one of regression model parameters, time constants, or process delays.

6. The method of claim 2, wherein the learning and preprocessing operation de-trends the historical data or real-time data by removing global or local deterministic trends among different process variables to bring non-stationary time series data into a quasi-stationary state.

7. The method of claim 2, wherein the learning and preprocessing operation tests for non-linearity and non-stationarity in the historical data or real-time data.

8. The method of claim 1, wherein the plurality of models consists of the group comprising an auto-regression exogenous (ARX) model, a principle component (PCA), dynamic PCA (DPCA), kernel PCA (KPCA), a partial least squares (PLS), dynamic PLS (DPLS) and kernel PLS (KPLS) models.

9. The method of claim 2, wherein the learning and preprocessing operation further includes, in the step of training, autonomously identifying model parameters for the selected model.

10. The method of claim 2, wherein the learning and preprocessing operation further includes, in the step of training, when the selected model has nonlinear extensions using different kernel functions, autonomously identifying a kernel function to provide a minimum residual.

11. The method of claim 1, wherein determining the existence of faults includes:
generating an estimated KPI value;
comparing the estimated KPI value with a received actual KPI value to determine a residual value; and
determining if the residual value exceeds a predetermined fault threshold.

12. The method of claim 11, wherein diagnosing and isolating the process variables upon determining a fault exists includes:
isolating at least one process variable;
processing the remaining process variables to evaluate a residual and assign a health index to the at least one isolated process variable; and
repeating the operation for each process variable.

13. A method comprising:
providing a database for storing model information for a plurality of available predictive models and for storing configuration information for configuring a predictive system;
storing, in the database, historical data for at least one process to be operated upon by the predictive system;
operating, in a learning mode, a processor to:
select historical data from the database for a given process,
analyze a data structure in the selected historical data,
determine and apply preconditioning parameters to precondition the selected historical data,
select one of the stored predictive models based on the data structure, and
train and test the selected predictive model to create a baseline model; and
operating, in an online mode, the processor to:
receive online data as process variables, key performance indicators (KPIs), and non-process data from the at least one process,
preprocess the received online data in accordance with the preconditioning parameters determined and used in the learning mode to precondition and parse the received online data as preprocessed process variables,
operate the baseline model on the preprocessed process variables and KPIs to determine residuals,
compare the determined residuals with stored fault threshold values to determine if a fault exists, and
when the fault has been determined to exist, analyze the fault with a predetermined fault analysis routine using the baseline model.

14. The method of claim 13, wherein the step of operating the baseline model to determine residuals includes:
mapping the preconditioned process variables through the baseline model to provide estimated values for the KPIs; and
determining, as the determined residual, a difference between the estimated values for the KPIs and received KPIs.

15. The method of claim 13, wherein step of analyzing the fault includes:
isolating at least one process variable, and
processing the received online data with the baseline model to evaluate any change in the determined residuals to determine which one or ones of the process variables contributes to the existence of the fault.

16. The method of claim 13, further comprising operating the processor further in the learning mode to:
clean noise or unworthy components of process variables, and
precondition and extract signal features for tuning purposes.

17. The method of claim 16, wherein the preconditioning includes:
labeling and categorizing the data selected, in the learning mode, from the database or received, in the online mode, from the at least one process into process variables, operating conditions, and KPIs.

18. The method of claim 16, wherein the preconditioning includes normalizing and scaling the data.

19. A predictive system comprising:
a database configured to store model information for a plurality of available predictive models and to store configuration information for configuring the predictive system;
the database configured to store historical data for at least one process to be operated upon by the predictive system;
a processor configured to operate in a learning mode to:
select historical data from the database for a given process,
analyze a data structure in the selected historical data,
determine and apply preconditioning parameters to precondition the selected historical data,
select one of the stored predictive models based on the data structure, and
train and test the selected predictive model to create a baseline model; and
the processor further configured to operate in an online mode to receive online data as process variables, key performance indicators (KPIs) and non-process data from the at least one process, and to perform fault analysis using the online data,
the processor operating in the online mode to perform fault analysis further configured to:
preprocess the received online data in accordance with the preconditioning parameters determined by the processor to precondition and parse the received online data as preprocessed process variables,
operate the baseline model on the preprocessed process variables and KPIs to determine residuals,
compare the determined residuals with stored fault threshold values to determine if a fault exists, and
when the fault has been determined to exist, analyze the fault with a predetermined fault analysis routine using the baseline model.

20. The system of claim 19, wherein:
the processor configured to determine if the fault exists is further configured to:
map the preprocessed process variables from an input to an output of the baseline model to provide estimated values for the KPIs, and
determine the estimated value for the KPIs from the output of the baseline model to determine a difference between the estimated values for the KPIs and received KPIs as the determined residuals; and
the processor configured to analyze the fault is further configured to:
isolate at least one process variable, and process remaining received online data after isolation of the at least one process variable to evaluate any change in the determined residuals to determine which one or ones of the process variables contributes to the existence of the fault.
